(19) United States
(12) Patent Application Publication
(10) Pub. No.: US 2010/0054211 A1
(43) Pub. Date: Mar. 4, 2010

(54) FREQUENCY DOMAIN PN SEQUENCE

(75) Inventor: Peter Gaal, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/501,243

(22) Filed: Jul. 10, 2009

Related U.S. Application Data
(60) Provisional application No. 61/092,200, filed on Aug. 27, 2008.

(51) Int. Cl. H04B 7/216; H04L 25/10; H04L 27/06; H04B 1/707; H04L 27/28

(52) U.S. Cl. 370/335; 375/319; 375/147; 375/141; 375/340; 375/260; 375/E01.002

(57) ABSTRACT

Systems and methodologies that enable implementing a complete period of frequency domain pseudo random/pseudo noise (PN) sequences, wherein the PN sequences satisfy predetermined requirements or relations. Such requirements or relations include: (1) supplying substantially low time domain Peak-to-Average Ratio (PAR); (2) supplying perfect periodic autocorrelation (zero out-of-phase correlation); (3) supplying substantially perfect cross correlation for any pair of sequences; and (4) supplying sequence correlation in the frequency domain by performing additive operations only or addition and subtraction-only. Taken together, such features in a family of sequences facilitate efficient signal transmission (e.g., substantially low power usage).

### CLAIM OF PRIORITY UNDER 35 U.S.C. §119

The present application for patent claims priority to Provisional Application No. 61/092,200 entitled “FREQUENCY DOMAIN PN SEQUENCE” filed Aug. 27, 2008, assigned to the assignee hereof and hereby expressly incorporated by reference herein in its entirety.

### BACKGROUND

I. Field

The following description relates generally to wireless communications and more particularly to properties of sets of frequency domain pseudo random/pseudo noise (PN) sequences.

II. Background

Wireless communication systems are widely deployed to provide various types of communication; for instance, voice and/or data can be provided via such wireless communication systems. A typical wireless communication system, or network, can provide multiple users access to one or more shared resources (e.g., bandwidth, transmit power, etc.). For instance, a system can use a variety of multiple access techniques such as Frequency Division Multiplexing (FDM), Time Division Multiplexing (TDM), Code Division Multiplexing (CDM), Orthogonal Frequency Division Multiplexing (OFDM), and others.

Generally, wireless multiple-access communication systems can simultaneously support communication for multiple access terminals. Each access terminal can communicate with one or more base stations via transmissions on forward and reverse links. The forward link (or downlink) refers to the communication link from base stations to access terminals, and the reverse link (or uplink) refers to the communication link from access terminals to base stations. This communication link can be established via a single-in-single-out, multiple-in-single-out or a multiple-in-multiple-out (MIMO) system.

MIMO systems commonly employ multiple (N_{T}) transmit antennas and multiple (N_{R}) receive antennas for data transmission. A MIMO channel formed by the N_{T} transmit and N_{R} receive antennas can be decomposed into N_{S} independent channels, which can be referred to as spatial channels, where N_{S}≦{N_{T}, N_{R}}. Each of the N_{S} independent channels corresponds to a dimension. Moreover, MIMO systems can provide improved performance (e.g., increased spectral efficiency, higher throughput and/or greater reliability) if the additional dimensionalities created by the multiple transmit and received antennas are utilized.

MIMO systems can support various duplexing techniques to divide forward and reverse link communications over a common physical medium. For instance, frequency division duplex (FDD) systems can utilize disparate frequency regions for forward and reverse link communications. Further, in time division duplex (TDD) systems, forward and reverse link communications can employ a common frequency region so that the reciprocity principle allows estimation of the forward link channel from reverse link channel.

Wireless communication systems oftentimes employ one or more base stations that provide a coverage area. A typical base station can transmit multiple data streams for broadcast, multicast and/or unicast services, wherein a data stream may be a stream of data that can be of independent reception interest to an access terminal. An access terminal within the coverage area of such base station can be employed to receive one, more than one, or all the data streams carried by the composite stream. Likewise, an access terminal can transmit data to the base station or another access terminal.

A typical wireless communication network (e.g., employing frequency, time and code division techniques) can include one or more base stations that provide a coverage area and one or more mobile (e.g., wireless) terminals that can transmit and receive data within the coverage area. A typical base station can simultaneously transmit multiple data streams for broadcast, multicast, and/or unicast services, wherein a data stream is a stream of data that can be of independent reception interest to a mobile terminal. A mobile terminal within the coverage area of that base station can be interested in receiving one, more than one or all the data streams carried by the composite stream. Likewise, a mobile terminal can transmit data to the base station or another mobile terminal. Such communication between access points and mobile terminals or between mobile terminals can take place after a terminal has “acquired” a base station serving a coverage sector. Typically, in an acquisition process a terminal accesses the necessary system information to communicate with the serving base station. As terminals enter and leave a sector without a specific pattern, acquisition information is frequently transmitted by the sector. The latter imposes a significant overhead in a wireless system.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

In one aspect, a method is provided for receiving wireless communication using a family of time domain pseudo-noise (PN) sequences based upon a frequency domain base PN sequence by employing a processor executing computer executable instructions stored on a computer readable storage medium to implement the following acts: A data packet communication signal is received that was transmitted on a plurality m of frequency domain available tones. A frequency domain binary pseudo-noise (PN) sequence aᵢ, i=0, 1, . . . , m−1 is accessed comprising a binary maximum length shift register sequence (m-sequence) whose members are mapped to ±1 from {0, 1}. A family of total number k of time domain sequence spectrum is generated by cyclically shifting the frequency domain binary PN sequence within the plurality m of frequency domain available consecutive tones. A series p=1, 2, . . . , k of sequence spectrum of the received data packet communication sequence are demodulated using the family of time domain PN sequences. The family of frequency domain PN sequences provides a low time domain peak-to-average (PAR) ratio, each PN sequence provides perfect autocorrelation thus zero out-of-phase correlation, any pair of PN sequences has substantially perfect cross-correlation; and sequence correlation in frequency domain achieved with addition-only or addition and subtraction-only operations.

In another aspect, a computer program product is provided for receiving wireless communication using a family of time domain pseudo-noise (PN) sequences based upon a frequency domain base PN sequence. At least one computer readable storage medium stores computer executable instructions that, when executed by at least one processor, implement components. A set of codes causes a computer to receive a data packet communication signal transmitted on a plurality m of frequency domain available tones. A set of codes causes the computer to access a frequency domain binary pseudo-noise (PN) sequence aᵢ, i=0, 1, . . . , m−1 comprising a binary maximum length shift register sequence (m-sequence) whose members are mapped to ±1 from {0, 1}. A set of codes causes the computer to generate a family of total number k of time domain sequence spectrum by cyclically shifting the frequency domain binary PN sequence within the plurality m of frequency domain available consecutive tones. A set of codes causes the computer to demodulate a series p=1, 2, . . . , k of sequence spectrum of the received data packet communication sequence using the family of time domain PN sequences. The family of frequency domain PN sequences provides a low time domain peak-to-average (PAR) ratio, each PN sequence provides perfect autocorrelation thus zero out-of-phase correlation, any pair of PN sequences has substantially perfect cross-correlation; and sequence correlation in frequency domain achieved with addition-only or addition and subtraction-only operations.

In an additional aspect, an apparatus is provided for receiving wireless communication using a family of time domain pseudo-noise (PN) sequences based upon a frequency domain base PN sequence. At least one computer readable storage medium stores computer executable instructions that when executed by at least one processor implement components. Means are provided for receiving a data packet communication signal transmitted on a plurality m of frequency domain available tones. Means are provided for accessing a frequency domain binary pseudo-noise (PN) sequence aᵢ, i=0, 1, . . . , m−1 comprising a binary maximum length shift register sequence (m-sequence) whose members are mapped to ±1 from {0, 1}. Means are provided for generating a family of total number k of time domain sequence spectrum by cyclically shifting the frequency domain binary PN sequence within the plurality m of frequency domain available consecutive tones. Means are provided for demodulating a series p=1, 2, . . . , k of sequence spectrum of the received data packet communication sequence using the family of time domain PN sequences. The family of frequency domain PN sequences provides low time domain peak-to-average (PAR) ratio, each PN sequence provides perfect autocorrelation thus zero out-of-phase correlation, any pair of PN sequences has substantially perfect cross-correlation; and sequence correlation in frequency domain achieved with addition-only or addition and subtraction-only operations.

In a further aspect, an apparatus is provided for receiving wireless communication using a family of time domain pseudo-noise (PN) sequences based upon a frequency domain base PN sequence. A receiver is for receiving a data packet communication signal transmitted on a plurality m of frequency domain available tones. A computer-readable storage medium is for accessing a frequency domain binary pseudo-noise (PN) sequence aᵢ, i=0, 1, . . . , m−1 comprising a binary maximum length shift register sequence (m-sequence) whose members are mapped to ±1 from {0, 1}. A computing platform is for generating a family of total number k of time domain sequence spectrum by cyclically shifting the frequency domain binary PN sequence within the plurality m of frequency domain available consecutive tones. A demodulator is for demodulating a series p=1, 2, . . . , k of sequence spectrum of the received data packet communication sequence using the family of time domain PN sequences. The family of frequency domain PN sequences provides low time domain peak-to-average (PAR) ratio, each PN sequence provides perfect autocorrelation thus zero out-of-phase correlation, any pair of PN sequences has substantially perfect cross-correlation; and sequence correlation in frequency domain achieved with addition-only or addition and subtraction-only operations.

In yet one aspect, a method is provided for transmitting wireless communication using a family of time domain pseudo-noise (PN) sequences based upon a frequency domain base PN sequence by employing a processor executing computer executable instructions stored on a computer readable storage medium to implement the following acts: A frequency domain binary pseudo-noise (PN) sequence aᵢ, i=0, 1, . . . , m−1 is accessed comprising a binary maximum length shift register sequence (m-sequence) whose members are mapped to ±1 from {0, 1}. A family of total number k of time domain sequence spectrum is generated by cyclically shifting the frequency domain binary PN sequence within the plurality m of frequency domain available consecutive tones. A data packet communication is modulated using the family of time domain PN sequences. The modulated data packet communication signal is transmitted on a plurality m of frequency domain available tones. The family of frequency domain PN sequences provides low time domain peak-to-average (PAR) ratio, each PN sequence provides perfect autocorrelation thus zero out-of-phase correlation, any pair of PN sequences has substantially perfect cross-correlation; and sequence correlation in frequency domain achieved with addition-only or addition and subtraction-only operations.

In yet another aspect, a computer program product is provided for transmitting wireless communication using a family of time domain pseudo-noise (PN) sequences based upon a frequency domain base PN sequence. At least one computer readable storage medium stores computer executable instructions that when executed by at least one processor implement components. A set of codes causes a computer to access a frequency domain binary pseudo-noise (PN) sequence aᵢ, i=0, 1, . . . , m−1 comprising a binary maximum length shift register sequence (m-sequence) whose members are mapped to ±1 from {0, 1}. A set of codes causes the computer to generate a family of total number k of time domain sequence spectrum by cyclically shifting the frequency domain binary PN sequence within the plurality m of frequency domain available consecutive tones. A set of codes causes the computer to modulate a data packet communication using the family of time domain PN sequences. A set of codes causes the computer to transmit the modulated data packet communication signal transmitted on a plurality m of frequency domain available tones. The family of frequency domain PN sequences provides a low time domain peak-to-average (PAR) ratio, each PN sequence provides perfect autocorrelation thus zero out-of-phase correlation, any pair of PN sequences has substantially perfect cross-correlation; and sequence correlation in frequency domain achieved with addition-only or addition and subtraction-only operations.

In yet an additional aspect, an apparatus is provided for transmitting wireless communication using a family of time domain pseudo-noise (PN) sequences based upon a frequency domain base PN sequence. At least one computer readable storage medium stores computer executable instructions that when executed by the at least one processor implement components. Means are provided for accessing a frequency domain binary pseudo-noise (PN) sequence aᵢ, i=0, 1, . . . , m−1 comprising a binary maximum length shift register sequence (m-sequence) whose members are mapped to ±1 from {0, 1}. Means for provided for generating a family of total number k of time domain sequence spectrum by cyclically shifting the frequency domain binary PN sequence within the plurality m of frequency domain available consecutive tones. Means are provided for modulating a data packet communication using the family of time domain PN sequences. Means are provided for transmitting the modulated data packet communication signal transmitted on a plurality m of frequency domain available tones. The family of frequency domain PN sequences provides low time domain peak-to-average (PAR) ratio, each PN sequence provides perfect autocorrelation thus zero out-of-phase correlation, any pair of PN sequences has substantially perfect cross-correlation; and sequence correlation in frequency domain achieved with addition-only or addition and subtraction-only operations.

In yet a further aspect, an apparatus is provided for transmitting wireless communication using a family of time domain pseudo-noise (PN) sequences based upon a frequency domain base PN sequence. A computer-readable storage medium is for accessing a frequency domain binary pseudo-noise (PN) sequence aᵢ, i=0, 1, . . . , m−1 comprising a binary maximum length shift register sequence (m-sequence) whose members are mapped to ±1 from {0, 1}. The computing platform is further for generating a family of total number k of time domain sequence spectrum by cyclically shifting the frequency domain binary PN sequence within the plurality m of frequency domain available consecutive tones. A modulator is for modulating a data packet communication using the family of time domain PN sequences. A transmitter is for transmitting the modulated data packet communication signal transmitted on a plurality m of frequency domain available tones. The family of frequency domain PN sequences provides low time domain peak-to-average (PAR) ratio, each PN sequence provides perfect autocorrelation thus zero out-of-phase correlation, any pair of PN sequences has substantially perfect cross-correlation; and sequence correlation in frequency domain achieved with addition-only or addition and subtraction-only operations.

To the accomplishment of the foregoing and related ends, the one or more aspects comprise the features hereinafter fully described and particularly pointed out in the claims. The following description and the annexed drawings set forth detail certain illustrative aspects of the one or more embodiments. These aspects are indicative, however, of but a few of the various ways in which the principles of various embodiments can be employed and the described embodiments are intended to include all such aspects and their equivalents.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout and wherein:

FIG. 1 illustrates a block diagram of a wireless communication system of a base node and user equipment using wireless communication using a family of time domain pseudo-noise (PN) sequences based upon a frequency domain base PN sequence.

FIG. 2 illustrates a block diagram of a pseudo random/pseudo noise (PN) generator that implements predetermined requirements/relations in accordance with various aspects set forth herein, and as part of a wireless communication system.

FIG. 3 illustrates a flow diagram for a methodology or sequence of operations for receiving wireless communication using a family of time domain pseudo-noise (PN) sequences based upon a frequency domain base PN sequence.

FIG. 4 illustrates a flow diagram for a methodology or sequence of operations for transmitting wireless communication using a family of time domain pseudo-noise (PN) sequences based upon a frequency domain base PN sequence.

FIG. 5 illustrates a communication system that employs a PN sequence according to a particular aspect of the subject innovation.

FIG. 6 illustrates a signaling modulator that implements PN sequencing according to a further aspect of the subject innovation.

FIG. 7 illustrates a pilot modulator that implements a PN sequence according to a further aspect of the subject innovation.

FIG. 8 illustrates an exemplary OFDM modulator as part of a communication system with PN according to a further aspect.

FIG. 9 illustrates an exemplary OFDM demodulator for an exemplary system according to an aspect.

FIG. 10 illustrates a further communication system with a PN generator that generates a PN sequence according to a particular aspect.

FIG. 11 illustrates a block diagram of a system comprising a logical grouping of electrical components for receiving wireless communication using a family of time domain pseudo-noise (PN) sequences based upon a frequency domain base PN sequence.

FIG. 12 illustrates a block diagram of a system comprising a logical grouping of electrical components for transmitting wireless communication using a family of time domain pseudo-noise (PN) sequences based upon a frequency domain base PN sequence.

FIG. 13 illustrates a block diagram of an apparatus comprising means for receiving wireless communication using a family of time domain pseudo-noise (PN) sequences based upon a frequency domain base PN sequence.

FIG. 14 illustrates a block diagram of an apparatus comprising means for transmitting wireless communication using a family of time domain pseudo-noise (PN) sequences based upon a frequency domain base PN sequence.

### DETAILED DESCRIPTION

In accordance with one or more aspects and corresponding disclosure thereof, various aspects are described in connection with employing a complete period of frequency domain pseudo random/pseudo noise (PN) sequences—(the binary maximum length shift register sequences referred to as m-sequences)—wherein the PN sequences satisfy predetermined requirements or relations. Such requirements or relations include:

(1) supplying substantially low time domain Peak-to-Average Ratio (PAR);

(2) supplying perfect periodic autocorrelation (zero out-of-phase correlation); 3—supplying substantially perfect cross correlation for any pair of sequences; and

(4) supplying sequence correlation in the frequency domain by performing additive operations only (as opposed to also using multiplicative operations). Taken together, such features in a family of sequences facilitate efficient signal transmission (e.g., substantially low power usage)—wherein different sequences in the family are generated as the frequency domain cyclic shift of each other. As such, for acquisition signals, aspects of the subject innovation supply a substantially large (relative to the sequence length) set of base sequences with a substantially low peak-to-average ratio, while maintaining autocorrelation/cross-correlation both with regards to zero and non-zero frequency offsets.

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

As used in this application, the terms “component,” “module,” “system,” and the like are intended to refer to a computer-related entity, either hardware, firmware, a combination of hardware and software, software, or software in execution. For example, a component can be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets (e.g., data from one component interacting with another component in a local system, distributed system, and/or across a network such as the Internet with other systems by way of the signal).

The techniques described herein can be used for various wireless communication systems such as code division multiple access (CDMA), time division multiple access (TDMA), frequency division multiple access (FDMA), orthogonal frequency division multiple access (OFDMA), single carrier-frequency division multiple access (SC-FDMA) and other systems. The terms “system” and “network” are often used interchangeably. A CDMA system can implement a radio technology such as Universal Terrestrial Radio Access (UTRA), CDMA2000, etc. UTRA includes Wideband-CDMA (W-CDMA) and other variants of CDMA. CDMA2000 covers IS-2000, IS-95 and IS-856 standards. A TDMA system can implement a radio technology such as Global System for Mobile Communications (GSM). An OFDMA system can implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) is an upcoming release of UMTS that uses E-UTRA, which employs OFDMA on the downlink and SC-FDMA on the uplink.

Single carrier frequency division multiple access (SC-FDMA) utilizes single carrier modulation and frequency domain equalization. SC-FDMA has similar performance and essentially the same overall complexity as those of an OFDMA system. A SC-FDMA signal has lower peak-to-average power ratio (PAPR) because of its inherent single carrier structure. SC-FDMA can be used, for instance, in uplink communications where lower PAPR greatly benefits access terminals in terms of transmit power efficiency. Accordingly, SC-FDMA can be implemented as an uplink multiple access scheme in 3GPP Long Term Evolution (LTE) or Evolved UTRA.

Furthermore, various embodiments are described herein in connection with an access terminal. An access terminal can also be called a system, subscriber unit, subscriber station, mobile station, mobile, remote station, remote terminal, mobile device, user terminal, terminal, wireless communication device, user agent, user device, or user equipment (UE). An access terminal can be a cellular telephone, a cordless telephone, a Session Initiation Protocol (SIP) phone, a wireless local loop (WLL) station, a personal digital assistant (PDA), a handheld device having wireless connection capability, computing device, or other processing device connected to a wireless modem. Moreover, various embodiments are described herein in connection with a base station. A base station can be utilized for communicating with access terminal(s) and can also be referred to as an access point, Node B, Evolved Node B (eNodeB) or some other terminology.

In addition, various aspects or features described herein can be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data.

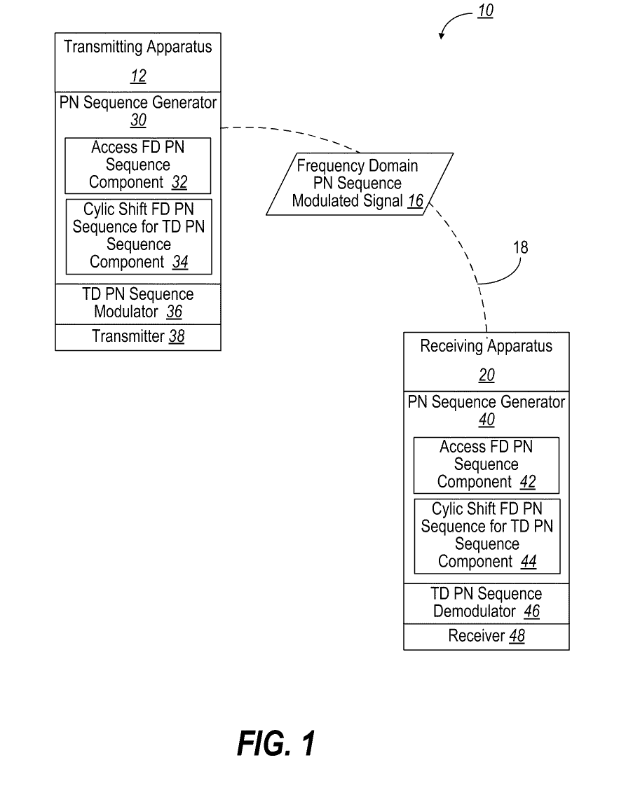

In FIG. 1, a communication system 10 includes a transmitting apparatus (e.g., a base station or node) 12 that transmits a time domain (TD) pseudo noise (PN) sequence modulated signal (e.g., control information, data code) 16 on a wireline or wireless channel 18 to a receiving apparatus (e.g., terminal, user equipment (UE)) 20. Advantageously, the transmitting apparatus 12 includes a PN sequence generator 30 that facilitates generation and use of a TD PN sequence. To that end, an access frequency domain (FD) PN sequence component 32 provides the FD PN sequence to a cyclic shift component 34 that performs a cyclic shift of the FD PN sequence to generate a TD PN sequence. This result is used by a modulator 36 to code, modulate or spread the signal 16 for transmission by a transmitter 38. Advantageously, the receiving apparatus 20 includes a PN sequence generator 40 that facilitates generation and use of a TD PN sequence. To that end, an access frequency domain (FD) PN sequence component 42 provides the FD PN sequence to a cyclic shift component 44 that performs a cyclic shift of the FD PN sequence to generate a TD PN sequence. This result is used by a demodulator 46 to decode, demodulate or de-spread the signal 16 that was received by receiver 48.

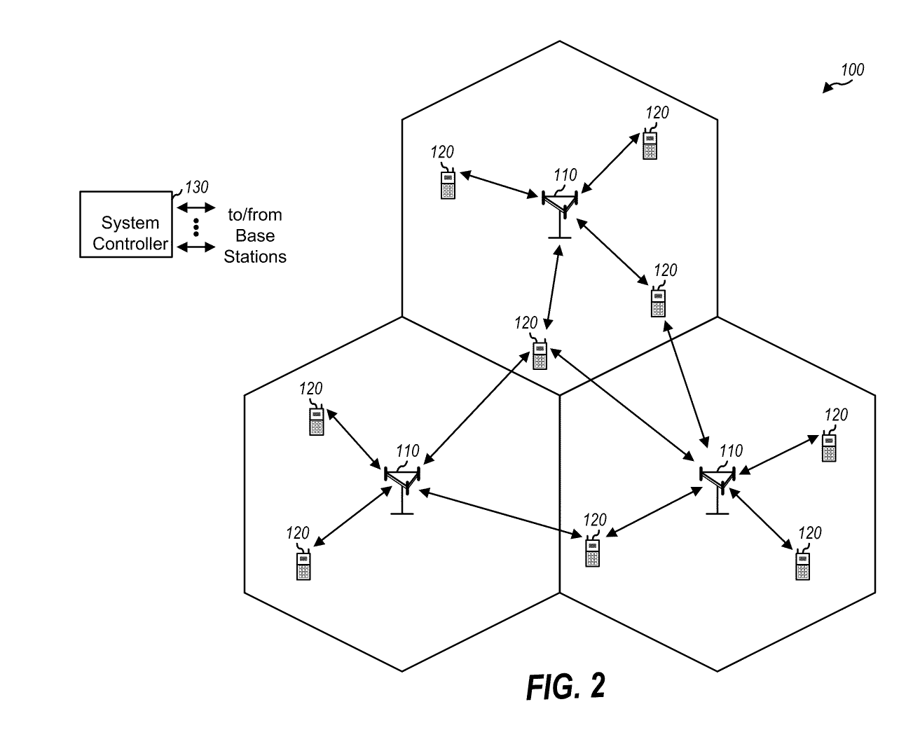

FIG. 2 illustrates a pseudo random/pseudo noise (PN) sequence generation in a wireless communication system 100 such as an OFDMA system with a number of base stations 110 that support communication for a number of wireless terminals 120. The wireless system 100 can employ a complete period of frequency domain PN sequences—(the binary maximum length shift register sequences referred to as m-sequences)—wherein the PN sequences satisfy predetermined requirements or relations. Such requirements or relations include: (1) supplying substantially low time domain Peak-to-Average Ratio (PAR); (2) supplying perfect periodic autocorrelation (zero out-of-phase correlation); (3) supplying substantially perfect cross correlation for any pair of sequences; and (4) supplying sequence correlation in the frequency domain by performing additive operations only. Taken together, such features in a family of sequences facilitate efficient signal transmission (e.g., substantially low power usage)-wherein different sequences in the family are generated as the frequency domain cyclic shift of each other.

A network controller 130 may couple to a set of base stations and provide coordination and control for these base stations. Network controller 130 may be a single network entity or a collection of network entities. Network controller 130 may communicate with base stations 110 via a backhaul. Backhaul network communication can facilitate point-to-point communication between base stations 110 employing such a distributed architecture. Base stations 110 may also communicate with one another, e.g., directly or indirectly via wireless or wireline backhaul.

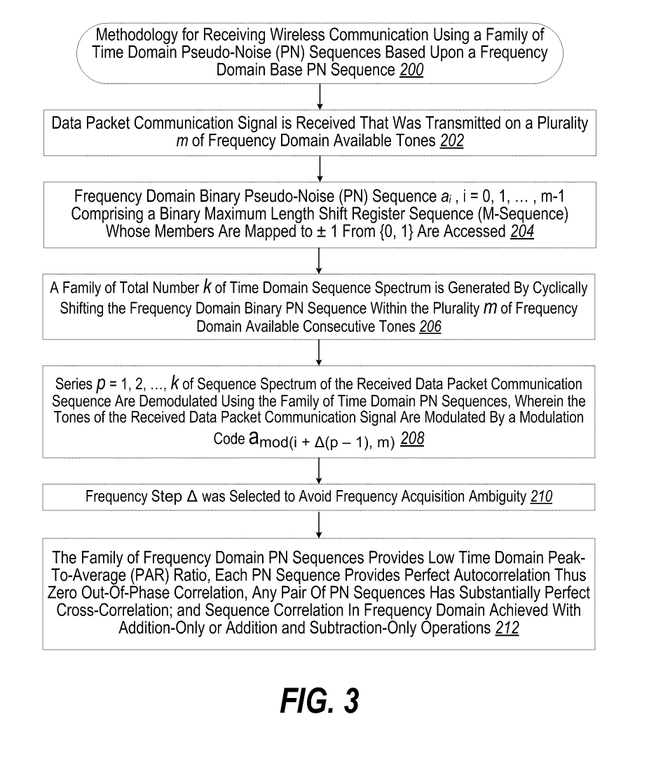

In FIG. 3, a methodology or sequence of operations 200 is provided for receiving wireless communication using a family of time domain pseudo-noise (PN) sequences based upon a frequency domain base PN sequence. In block 202, a data packet communication signal is received that was transmitted on a plurality m of frequency domain available tones. In block 204, a frequency domain binary pseudo-noise (PN) sequence aᵢ, i=0, 1, . . . , m−1 comprising a binary maximum length shift register sequence (m-sequence) whose members are mapped to ±1 from {0, 1} are accessed. In block 206, a family of total number k of time domain sequence spectrum is generated by cyclically shifting the frequency domain binary PN sequence within the plurality m of frequency domain available consecutive tones. In block 208, a series p=1, 2, . . . , k of sequence spectrum of the received data packet communication sequence are demodulated using the family of time domain PN sequences, wherein the tones of the received data packet communication signal are modulated by a modulation code a_{mod(i+Δ(p-1),m)}. In block 210, frequency step Δ was selected to avoid frequency acquisition ambiguity. In block 212, the family of frequency domain PN sequences provides low time domain peak-to-average (PAR) ratio, each PN sequence provides perfect autocorrelation thus zero out-of-phase correlation, any pair of PN sequences has substantially perfect cross-correlation; and sequence correlation in frequency domain achieved with addition-only or addition and subtraction-only operations.

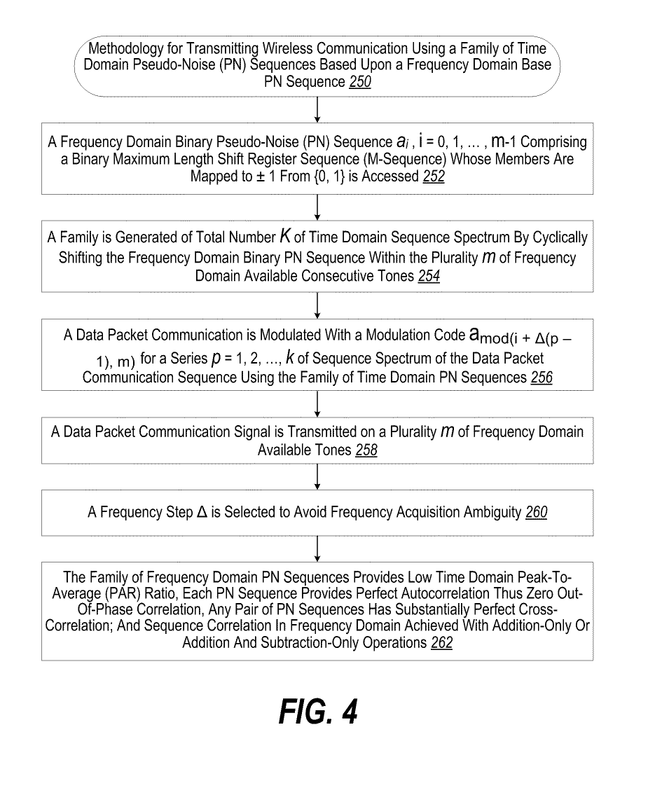

In FIG. 4, a methodology or sequence of operations 250 is provided for transmitting wireless communication using a family of time domain pseudo-noise (PN) sequences based upon a frequency domain base PN sequence. In block 252, a frequency domain binary pseudo-noise (PN) sequence aᵢ, i=0, 1, . . . , m−1 comprising a binary maximum length shift register sequence (m-sequence) whose members are mapped to ±1 from {0, 1} is accessed. In block 254, a family is generated of total number k of time domain sequence spectrum by cyclically shifting the frequency domain binary PN sequence within the plurality m of frequency domain available consecutive tones. In block 256, a data packet communication is modulated with a modulation code a_{mod(i+Δ(p-1),m)} for a series p=1, 2, . . . , k of sequence spectrum of the data packet communication sequence using the family of time domain PN sequences. In block 258, a data packet communication signal is transmitted on a plurality m of frequency domain available tones. In block 260, a frequency step Δ is selected to avoid frequency acquisition ambiguity. In block 262, the family of frequency domain PN sequences provides low time domain peak-to-average (PAR) ratio, each PN sequence provides perfect autocorrelation thus zero out-of-phase correlation, any pair of PN sequences has substantially perfect cross-correlation; and sequence correlation in frequency domain achieved with addition-only or addition and subtraction-only operations.

In one aspect, it can be assumed that the transmit signal is generated by an N-point IFFT followed by cyclic prefix insertion, windowing, and the like. Moreover, it can be assumed that in an acquisition slot, one has m, m<N consecutive tones available for the acquisition sequence, where m=2^{l}−1 for an l (m, N, l are integers.) The remainder of the tones can be employed for FDM data, or can be set to zero. One can also employ sequence repetition, which can require m=2(2^{l}−1) tones, and every other tone would be used only. It is to be appreciated that even though the following discussion is primarily described in the case of no sequence repetition and no data FDM, the subject innovation is not so limited and other aspects are well within the realm of the subject innovation.

According to a further aspect, the frequency domain PN sequences can be described as follows: let aᵢ, i=0, 1, . . . , m−1 be a binary PN sequence, whose elements are mapped to +/−1 (from {0, 1}). The m available consecutive tones are modulated with the consecutive elements of aᵢ to obtain the first sequence spectrum. A total of k sequence spectrums can be generated, each of which is obtained by cyclically shifting the first spectrum within the m available tones. Therefore the pth sequence spectrum employs the same set of tones as the first sequence spectrum and the tones are modulated by a_{mod(i+Δ(p-1),m)}, where p is the sequence index, p=1, 2, . . . , k, and Δ is an appropriately selected frequency increment. Typically, Δ should be sufficiently large to avoid frequency acquisition ambiguity problems. It is to be appreciated that a uniform step size Δ is not necessary. In particular, if k does not divide m evenly, then having a uniform Δ is not possible—yet such does not represent a practical problem.

The k time domain sequences can be achieved by obtaining the IFFT of each of the k frequency domain sequence spectra, followed by cyclic prefix insertion, windowing, interpolation, and the like. When calculating the correlation of sequences, the following identity can be employed:

$${{\sum }_{i = 0}^{m - 1} {s}_{i} \cdot {r}_{mod ( i + d , m )}^{*} = IFFT \{ S \cdot {R}^{*} \} \vert}_{d} \qquad ( 1 )$$

Wherein, sᵢ and rᵢ are arbitrary time domain sequences of length m, and S=FFT{s}, R=FFT{r} and where ƒ(t)|_{d} signifies evaluating a function ƒ(t) at t=d.

Put differently, one can exploit the fact that time domain convolution (or correlation) is equivalent to frequency domain multiplication with the spectrum (or the conjugate spectrum). This holds even if the roles of FFT and IFFT are changed. (In general, lower case letters can denote time domain variables and upper case letters can denote frequency domain variables.)

Time Domain Peak-to-Average

Likewise, for the time domain peak-to-average the time domain envelope for a frequency domain PN sequence sᵢ can be determined based on Equation (1) as follows:

$${{{s}_{i} \cdot {s}_{i}^{*} = IFFT \{ {\sum }_{I = 0}^{m - 1} {S}_{I} \cdot {S}_{mod ( I + d , m )}^{*} \} \vert}_{i} = IFFT \{ [ m , - 1 , - 1 , … , - 1 ] \} \vert}_{i}$$

Therefore one can obtain

$$\vert {s}_{i} \vert = \{ \begin{matrix}\frac{1}{m} & i = 0 \\ \frac{\sqrt{m + 1}}{m} & i \neq 0\end{matrix}$$

As indicated, the time domain signal has a constant envelope, except for a dip at i=0, which gives a negligible rise in PAR. Moreover, subsequent time domain interpolation (pulse shaping) can also increase the PAR but any significant increase is unlikely. It is to be appreciated that due to the short sequence length, statistical methods such as finding 0.1% or 0.01% CDF points become meaningless or of low importance. For the same reason, it is likely that different frequency domain PN sequences of the same length (corresponding to different generating polynomials) can result in slightly different PAR in the time domain.

Autocorrelation

Similarly, by employing Equation (1), one can obtain

$${{{\sum }_{i = 0}^{m - 1} {s}_{i} \cdot {s}_{mod ( i + d , m )}^{*} = IFFT \{ S \cdot {S}^{*} \} \vert}_{d} = IFFT \{ [ 1 , 1 , … , 1 ] \} \vert}_{d}$$

Therefore one can obtain

$${\sum }_{i = 0}^{m - 1} {s}_{i} \cdot {s}_{mod ( i + d , m )}^{*} = \{ \begin{matrix}1 & d = 0 \\ 0 & d \neq 0\end{matrix}$$

and hence, the sequences demonstrate perfect auto-correlation.

### Cross-Correlation

Accordingly, and because of such perfect autocorrelation, the m cyclic shifts of sᵢ span a full orthogonal base. Therefore, any cyclic shift of any other sequence rᵢ cannot be simultaneously orthogonal to all shifts of sᵢ. In particular, exactly because of the cyclic shifts of sᵢ being an orthogonal base, the following identity holds:

$${\sum }_{d = 0}^{m - 1} {\vert {\sum }_{i = 0}^{m - 1} {s}_{i} \cdot {r}_{mod ( i + d , m )}^{*} \vert}^{2} = {\sum }_{i = 0}^{m - 1} {\vert {r}_{i} \vert}^{2}$$

Put differently, the sum of all absolute squared correlation values with rᵢ will be equal to the sum of absolute squared values of the time samples of rᵢ: A perfect cross-correlation can then be obtained, if all correlation absolute values were equal, which would result in the maximum possible minimum distance between the time shifts of sᵢ and rᵢ. One can determine the time domain cross-correlation of two frequency domain PN sequences, sᵢ and rᵢ, where the second sequence is generated by the frequency domain cyclic shift of the first sequence. Equation (1) can then be employed to obtain:

$${{{\sum }_{i = 0}^{m - 1} {s}_{i} \cdot {r}_{mod ( i + d , m )}^{*} = IFFT \{ S \cdot {R}^{*} \} \vert}_{d} = IFFT \{ S \cdot R \} \vert}_{d}$$

Since the two spectra S and R are PN sequences, their elements are real and their element-wise product is just another shift of the same PN sequence. Therefore, the cross-correlation magnitude can be determined very similarly to the way the PAR was determined in the Time Domain Peak-to-Average described above.

Therefore, one can obtain:

$$\vert {\sum }_{i = 0}^{m - 1} {s}_{i} \cdot {r}_{mod ( i + d , m )}^{*} \vert = \{ \begin{matrix}\frac{1}{m} & d = 0 \\ \frac{\sqrt{m + 1}}{m} & d \neq 0\end{matrix}$$

Put differently, the sequences can demonstrate substantially perfect cross-correlation. Moreover, the fact that there exists a dip at time offset d=0 does not represent a practical problem. As such, for acquisition signals, aspects of the subject innovation supply a substantially large (relative to the sequence length) set of base sequences with substantially low peak-to-average ratio, while maintaining autocorrelation/cross correlation both with regards to zero and non-zero frequency offsets.

As illustrated in FIG. 2, the PN sequences can be associated with transmitting a signal between the base station and a terminal. A base station is a fixed station used for communicating with the terminals and may also be called an access point, a Node B, or some other terminology. Terminals 120 are typically dispersed throughout the system, and each terminal may be fixed or mobile. A terminal may also be called a mobile station, a user equipment (UE), a wireless communication device, or some other terminology. Each terminal may communicate with one or possibly multiple base stations on the forward and reverse links at any given moment. A system controller 130 provides coordination and control for base stations 110 and further controls routing of data for the terminals served by these base stations.

Each base station 110 provides communication coverage for a respective geographic area. A base station and/or its coverage area may be referred to as a “cell”, depending on the context in which the term is used. To increase capacity, the coverage area of each base station may be partitioned into multiple (e.g., three) sectors. Each sector is served by a base transceiver subsystem (BTS). For a sectorized cell, the base station for that cell typically includes the BTSs for all sectors of that cell. For simplicity, in the following description, the term “base station” is used generically for both a fixed station that serves a cell and a fixed station that serves a sector. The terms “user” and “terminal” are also used interchangeably herein.

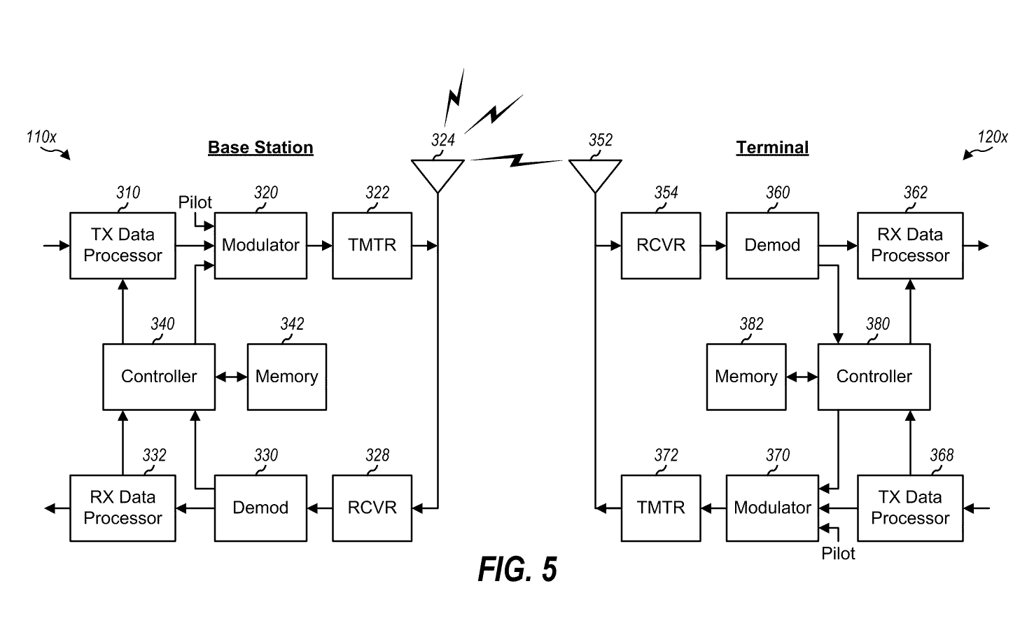

In a related aspect, FIG. 5 shows a block diagram of a base station 110x and a terminal 120x, which are one of the base stations and terminals in FIG. 3. For the forward link, at base station 110x, a transmit (TX) data processor 310 receives traffic data for all of the terminals, processes (e.g., encodes, interleaves, and symbol maps) the traffic data for each terminal based on a coding and modulation scheme selected for that terminal, and provides data symbols for each terminal. A modulator 320 receives the data symbols for all terminals, pilot symbols, and signaling for all terminals (e.g., from a controller 340), performs modulation for each type of data as described below, and provides a stream of output chips. A transmitter unit (TMTR) 322 processes (e.g., converts to analog, filters, amplifies, and frequency upconverts) the output chip stream to generate a modulated signal, which is transmitted from an antenna 324.

At terminal 120x, the modulated signal transmitted by base station 110x and possibly other base stations are received by an antenna 352. A receiver unit (RCVR) 354 processes (e.g., conditions and digitizes) the received signal from antenna 352 and provides received samples. A demodulator (Demod) 360 processes (e.g., demodulates and detects) the received samples and provides detected data symbols for terminal 120x. Each detected data symbol is a noisy estimate of a data symbol transmitted by base station 110x to terminal 120x. A receive (RX) data processor 362 processes (e.g., symbol demaps, deinterleaves, and decodes) the detected data symbols and provides decoded data.

For the reverse link, at terminal 120x, traffic data is processed by a TX data processor 368 to generate data symbols. A modulator 370 processes the data symbols, pilot symbols, and signaling from terminal 120x for the reverse link and provides an output chip stream, which is further conditioned by a transmitter unit 372 and transmitted from antenna 352. At base stations 110x, the modulated signals transmitted by terminal 120x and other terminals are received by antenna 324, conditioned and digitized by a receiver unit 328, and processed by a demodulator 330 to detect the data symbols and signaling sent by each terminal. An RX data processor 332 processes the detected data symbols for each terminal and provides decoded data for the terminal. Controller 340 receives the detected signaling data and controls the data transmissions on the forward and reverse links. Controllers 340 and 380 direct the operation at base station 110x and terminal 120x, respectively. Memory units 342 and 382 store program codes and data used by controllers 340 and 380, respectively.

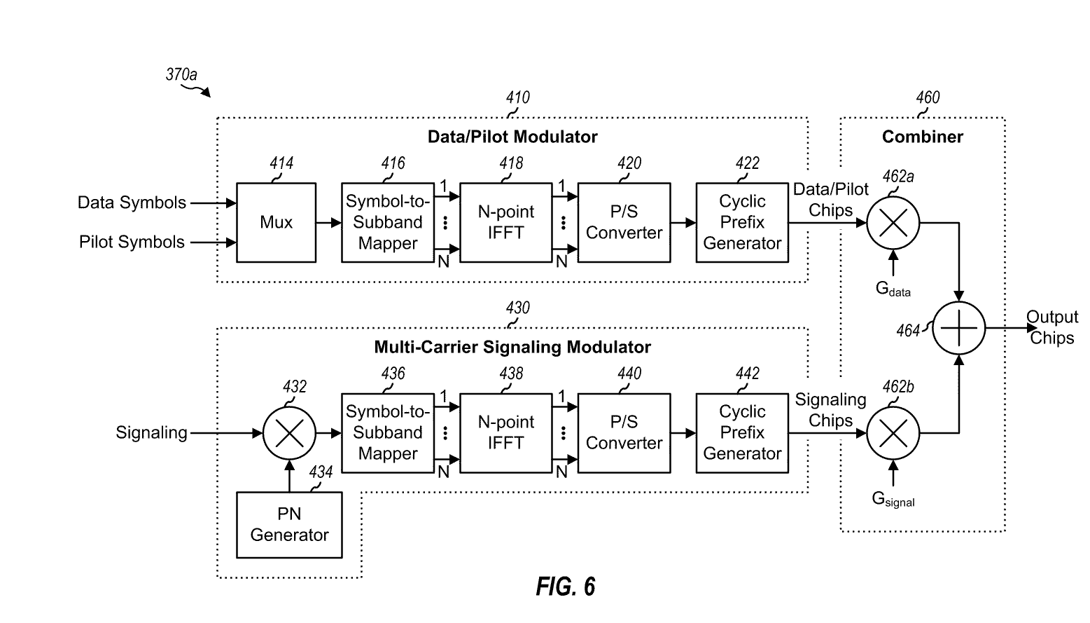

FIG. 6 illustrates a block diagram of a modulator 370a, which may be used for modulator 320 or 370 in FIG. 5. Modulator 370a includes (1) a data/pilot modulator 410 that can send data and pilot symbols in a TDM or FDM manner, (2) a multi-carrier signaling modulator 430 that can send signaling as underlay on all of a subset of the N usable subbands, and (3) a combiner 460 that performs time-domain combining.

Within data/pilot modulator 410, a multiplexer (Mux) 414 receives and multiplexes data symbols with pilot symbols. For each OFDM symbol period, a symbol-to-subband mapper 416 maps the multiplexed data and pilot symbols onto the subbands assigned for data and pilot transmission in that symbol period. Mapper 416 also provides a signal value of zero for each subband not used for transmission. For each symbol period, mapper 416 provides N transmit symbols for the N total subbands, where each transmit symbol may be a data symbol, a pilot symbol, or a zero-signal value. For each symbol period, an inverse fast Fourier transform (IFFT) unit 418 transforms the N transmit symbols to the time domain with an N-point IFFT and provides a “transformed” symbol that contains N time-domain chips. Each chip is a complex value to be transmitted in one chip period. A parallel-to-serial (P/S) converter 420 serializes the N time-domain chips. A cyclic prefix generator 422 repeats a portion of each transformed symbol to form an OFDM symbol that contains N+C chips, where C is the number of chips being repeated. The repeated portion is often called a cyclic prefix and is used to combat inter-symbol interference (ISI) caused by frequency selective fading. An OFDM symbol period corresponds to the duration of one OFDM symbol, which is N+C chip periods. Cyclic prefix generator 422 provides a stream of data/pilot chips. IFFT unit 418, P/S converter 420, and cyclic prefix generator 422 form an OFDM modulator.

Within signaling modulator 430, a multiplier 432 receives and multiplies signaling data with a PN sequence from a PN generator 434 and provides spread signaling data. The signaling data for each terminal is spread with the PN sequence assigned to the terminal. A symbol-to-subband mapper 436 maps the spread signaling data onto the subbands used for signaling transmission, which may be all or a subset of the N usable subbands. An IFFT unit 438, a P/S converter 440, and a cyclic prefix generator 442 perform OFDM modulation on the mapped and spread signaling data and provide a stream of signaling chips.

Within combiner 460, a multiplier 462a multiplies the data/pilot chips from modulator 410 with a gain of G_{data}. A multiplier 462b multiplies the signaling chips from modulator 430 with a gain of G_{signal}. The gains G_{data} and G_{signal} determine the amount of transmit power to use for traffic data and signaling, respectively, and may be set to achieve good performance for both. A summer 464 sums the scaled chips from multipliers 462a and 462b and provides the output chips for modulator 370a.

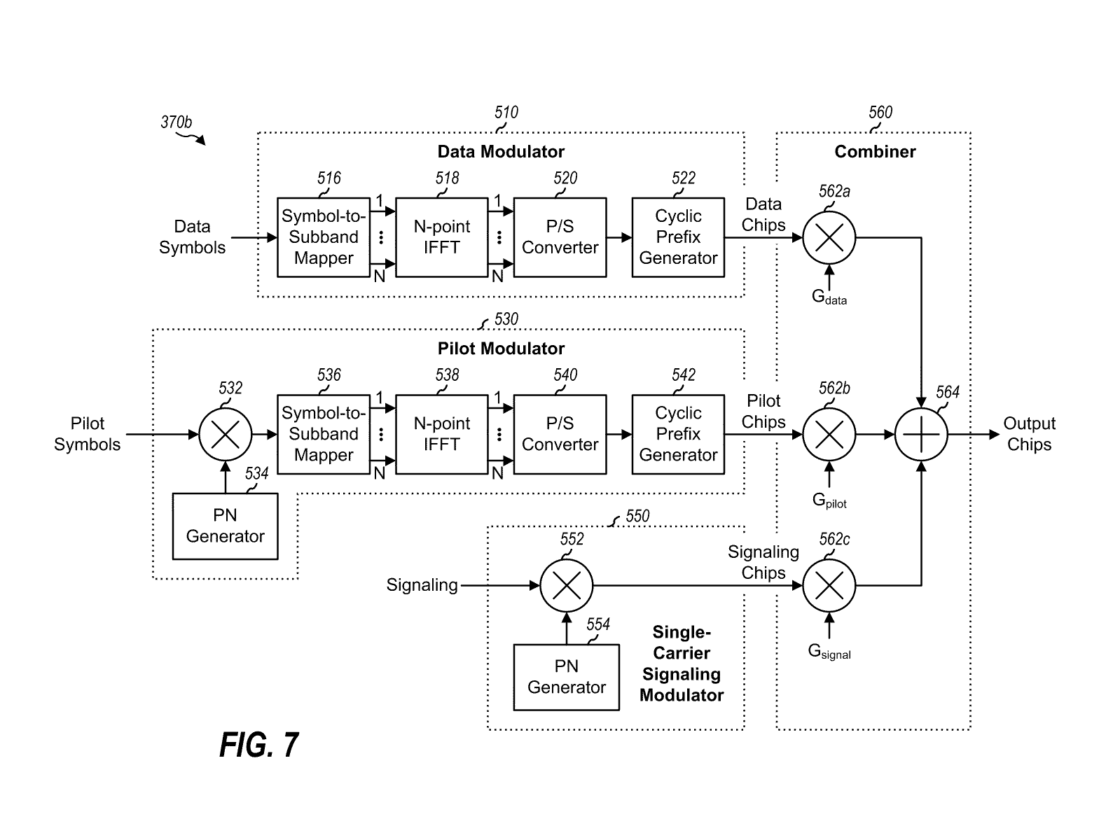

FIG. 7 illustrates a block diagram of a modulator 370b, which may also be used for modulator 320 or 370 in FIG. 5. Modulator 370b includes (1) a data modulator 510 that can send data symbols on subbands used for data transmission, (2) a pilot modulator 530 that can send pilot symbols as underlay on all of a subset of the N usable subbands, (3) a single-carrier signaling modulator 550 that can send signaling as underlay on all N usable subbands, and (4) a combiner 560 that performs time-domain combining.

Data modulator 510 includes a symbol-to-subband mapper 516, an IFFT unit 518, a P/S converter 520, and a cyclic prefix generator 522 that operate in the manner described above for units 416, 418, 420, and 422, respectively, in FIG. 6. Data modulator 510 performs OFDM modulation on data symbols and provides data chips. Pilot modulator 530 includes a multiplier 532, a PN generator 534, a symbol-to-subband mapper 536, an IFFT unit 538, a P/S converter 540, and a cyclic prefix generator 542 that operate in the manner described above for units 432, 434, 436, 438, 440, and 442, respectively, in FIG. 6. However, pilot modulator 530 operates on pilot symbols instead of signaling data. Pilot modulator 530 spreads the pilot symbols with a PN sequence, maps the spread pilot symbols onto subbands and symbol periods used for pilot transmission, and performs OFDM modulation on the mapped and spread pilot symbols to generate pilot chips. Different PN codes may be used for pilot and signaling. The pilot symbols may be spread over frequency, time, or both by selecting the proper PN code for the pilot. For example, a pilot symbol may be spread across S subbands in one symbol period by multiplying with an S-chip PN sequence, spread across R symbol periods on one subband by multiplying with an R-chip PN sequence, or spread across all S subbands and R symbol periods of one hop period by multiplying with an S×R-chip PN sequence.

Signaling modulator 550 includes a multiplier 552 and a PN generator 554 that operate in the manner described above for units 432 and 434, respectively, in FIG. 6. Signaling modulator 550 spreads the signaling data across all N usable subbands in the time domain and provides signaling chips. Signaling modulator 550 performs spreading in a manner similar to that performed for the reverse link in IS-95 and IS-2000 CDMA systems.

Within combiner 560, multipliers 562a, 562b, and 562c multiply the chips from modulators 510, 530, and 550, respectively, with gains of G_{data}, Gₚᵢₗₒₜ, and G_{signal}, respectively, which determine the amount of transmit power used for traffic data, pilot, and signaling, respectively. A summer 564 sums the scaled chips from multipliers 562a, 562b, and 562c and provides the output chips for modulator 550b.

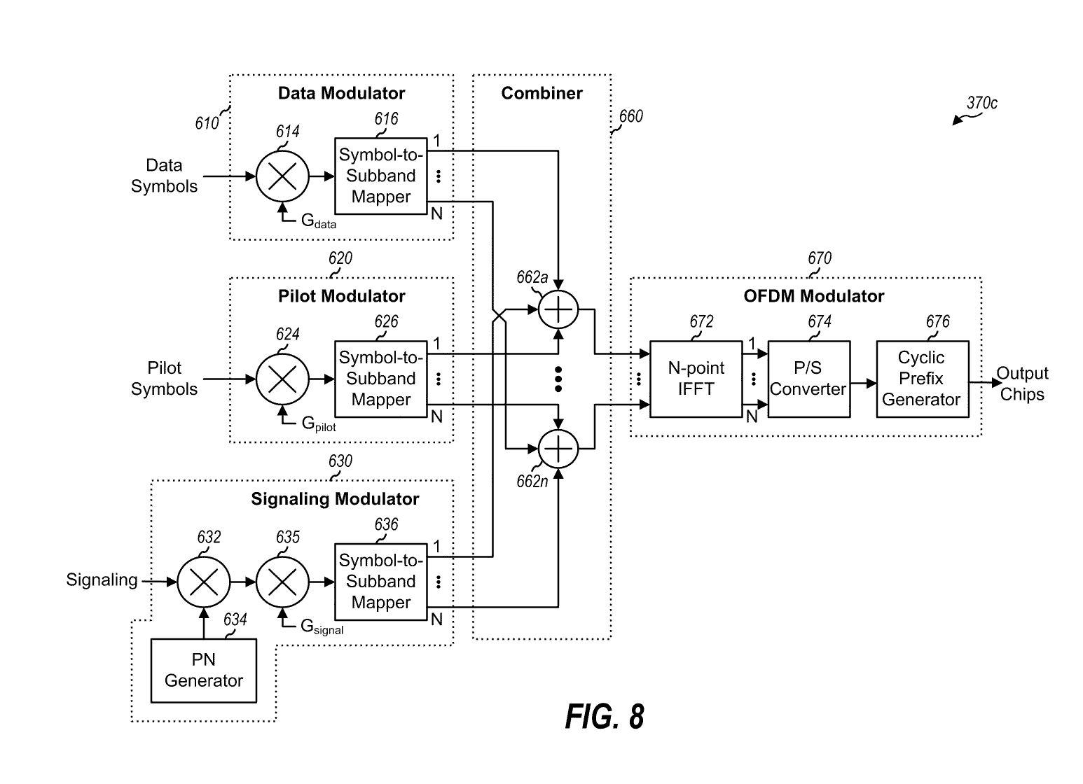

FIG. 8 shows a block diagram of a modulator 370c, which may also be used for modulator 320 or 370 in FIG. 5. Modulator 370c includes (1) a data modulator 610 that maps data symbols onto subbands used for data transmission (2) a pilot modulator 620 that maps pilot symbols onto subbands used for pilot transmission, (3) a multi-carrier signaling modulator 630, (4) a combiner 660 that performs frequency-domain combining, and (5) an OFDM modulator 670.

Within data modulator 610, a multiplier 614 receives and scales data symbols with a gain of G_{data} and provides scaled data symbols. A symbol-to-subband mapper 616 then maps the scaled data symbols onto the subbands used for data transmission. Within pilot modulator 620, a multiplier 624 receives and scales pilot symbols with a gain of Gₚᵢₗₒₜ and provides scaled pilot symbols. A symbol-to-subband mapper 626 then maps the scaled pilot symbols onto the subbands used for pilot transmission. Within signaling modulator 630, a multiplier 632 spreads signaling data across the subbands used for signaling transmission with a PN sequence generated by a PN generator 634. A multiplier 635 scales the spread signaling data with a gain of G_{signal} and provides scaled and spread signaling data, which is then mapped onto the subbands used for signaling transmission by a symbol-to-subband mapper 636. Combiner 660 includes N summers 662a through 662n for the N total subbands. For each symbol period, each summer 662 sums the scaled data, pilot, and signaling symbols for the associated subband and provides a combined symbol. OFDM modulator 670 includes an IFFT unit 672, a P/S converter 674, and a cyclic prefix generator 676 that operate in the manner described above for units 418, 420, and 422, respectively, in FIG. 6. OFDM modulator 670 performs OFDM modulation on the combined symbols from combiner 660 and provides output chips for modulator 370c. As illustrated in FIG. 8, the output of multiplier 632 may be provided to another input of multiplexer 614. Mapper 616 may then map the data symbols, pilot symbols, and spread signaling data onto the proper subbands designated for traffic data, pilot, and signaling, respectively.

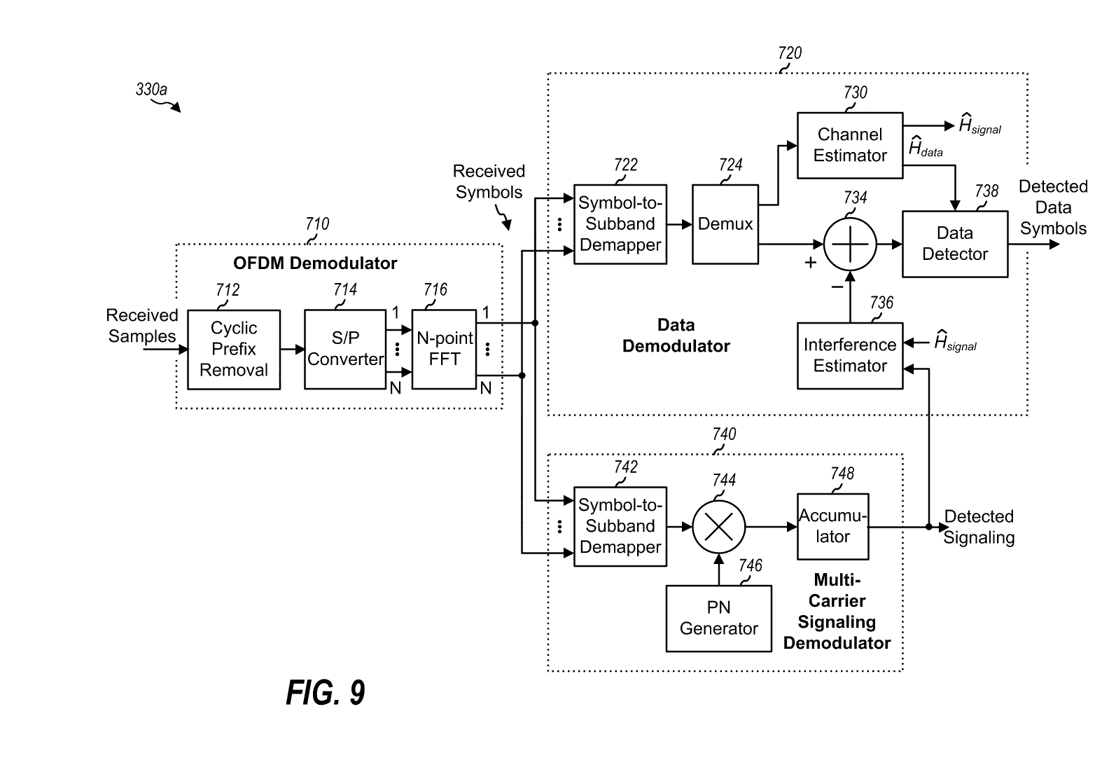

FIG. 9 shows a block diagram of a demodulator 330a, which may be used for demodulator 330 or 360 in FIG. 3. Demodulator 330a performs processing complementary to the processing performed by modulator 370a in FIG. 6. As explained earlier, demodulator 330a can include an OFDM demodulator 310, a data demodulator 320, and a multi-carrier signaling demodulator 340.

Within OFDM demodulator 710, a cyclic prefix removal unit 712 obtains N+C received samples for each OFDM symbol period, removes the cyclic prefix, and provides N received samples for a received transformed symbol. A serial-to-parallel (S/P) converter 714 provides the N received samples in parallel form. An FFT unit 716 transforms the N received samples to the frequency domain with an N-point FFT and provides N received symbols for the N total subbands. Within signaling demodulator 740, a symbol-to-subband demapper 742 obtains the received symbols for all N total subbands from OFDM demodulator 710 and passes only the received symbols for the subbands used for signaling transmission. A multiplier 744 multiplies the received symbols from demapper 742 with the PN sequence used for signaling, which is generated by a PN generator 746. An accumulator 748 accumulates the output of multiplier 744 over the length of the PN sequence and provides detected signaling data.

Within data demodulator 720, a symbol-to-subband demapper 722 obtains the received symbols for all N total subbands and passes only the received symbols for the subbands used for traffic data and pilot. A demultiplexer (Demux) 724 provides received pilot symbols to a channel estimator 730 and received data symbols to a summer 734. Channel estimator 730 processes the received pilot symbols and derives a channel estimate Ĥ_{data} for the subbands used for traffic data and a channel estimate Ĥ_{signal} for the subbands used for signaling. An interference estimator 736 receives the detected signaling data and the Ĥ_{signal} channel estimate, estimates the interference due to the detected signaling data, and provides an interference estimate to summer 734. Summer 734 subtracts the interference estimate from the received data symbols and provides interference-canceled symbols. The interference estimation and cancellation may be omitted, e.g., if the Ĥ_{signal} channel estimate is not available. A data detector 738 performs data detection (e.g., matched filtering, equalization, and so on) on the interference-canceled symbols with the Ĥ_{data} channel estimate and provides detected data symbols.

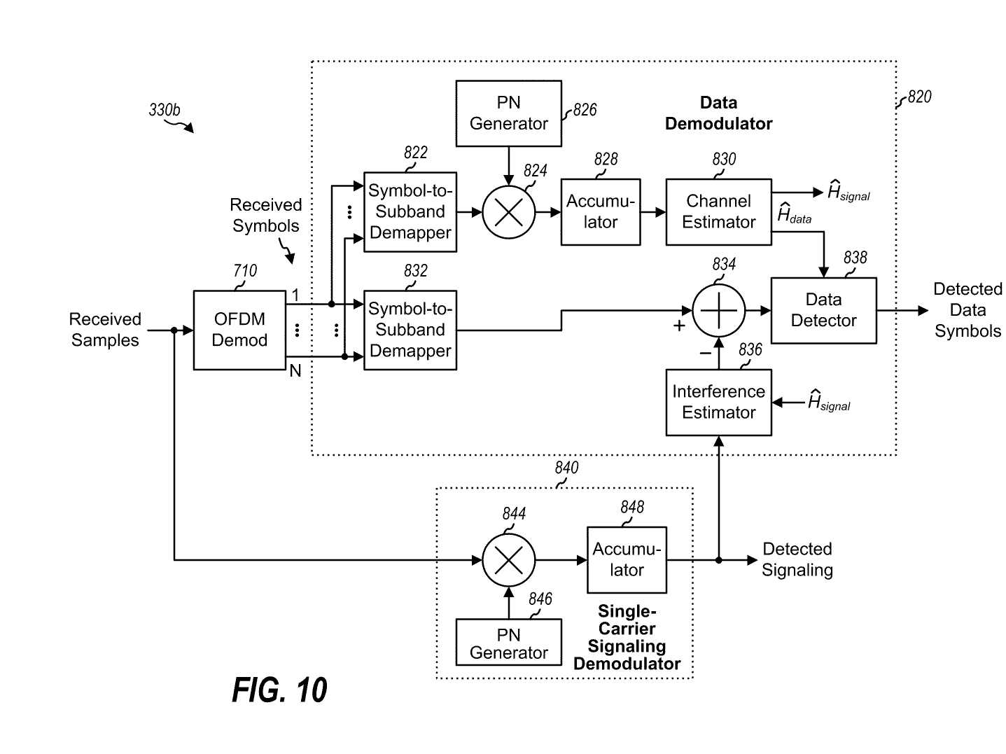

FIG. 10 illustrates a block diagram of a demodulator 330b, which may also be used for demodulator 330 or 360 in FIG. 5. Demodulator 330b performs processing complementary to the processing performed by modulator 370b in FIG. 5. Demodulator 330b includes OFDM demodulator 710 of FIG. 9, a data demodulator 820, and a signaling demodulator 840.

Within signaling demodulator 840, a multiplier 844 multiplies the data samples with the PN sequence used for signaling, which is generated by a PN generator 846. An accumulator 848 accumulates the output of multiplier 844 over the length of the PN sequence and provides the detected signaling data. Within data demodulator 820, a symbol-to-subband demapper 822 obtains the received symbols for all N total subbands from OFDM demodulator 710 and passes only the received pilot symbols for the subbands used for pilot transmission. A multiplier 824 and an accumulator 828 perform despreading on the received pilot symbols with the PN sequence used for the pilot, which is generated by a PN generator 826. The pilot despreading is performed in a manner complementary to the pilot spreading. A channel estimator 830 processes the despread pilot symbols and derives the Ĥ_{data} channel estimate for the subbands used for traffic data and the Ĥ_{signal} channel estimate for the subbands used for signaling.

A symbol-to-subband demapper 832 also obtains the received symbols for all N total subbands and passes only the received data symbols for the subbands used for traffic data. An interference estimator 836 estimates the interference due to the detected signaling and provides the interference estimate to a summer 834, which subtracts the interference estimate from the received data symbols and provides the interference-canceled symbols. A data detector 838 performs data detection on the interference-canceled symbols with the Ĥ_{data} channel estimate and provides the detected data symbols. It is to be appreciated that other designs may also be used for the demodulator, and are well within the scope of the invention. In general, the processing by the demodulator at one entity is determined by, and is complementary to, the processing by the modulator at the other entity.

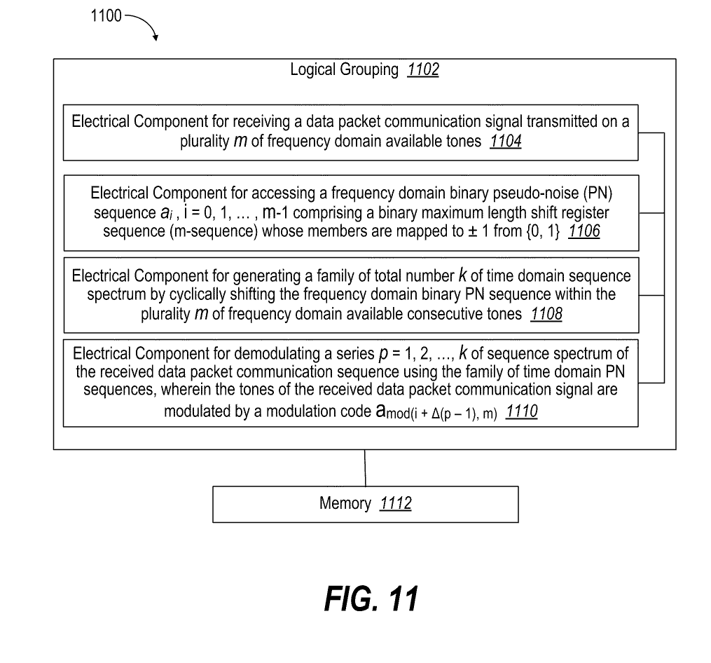

In FIG. 11, a system 1100 is depicted for receiving wireless communication using a family of time domain pseudo-noise (PN) sequences based upon a frequency domain base PN sequence. For example, system 1100 can reside at least partially within user equipment (UE). It is to be appreciated that system 1100 is represented as including functional blocks, which can be functional blocks that represent functions implemented by a processor, software, or combination thereof (e.g., firmware). System 1100 includes a logical grouping 1102 of electrical components that can act in conjunction. For instance, logical grouping 1102 can include an electrical component for receiving a data packet communication signal transmitted on a plurality m of frequency domain available tones 1104. Moreover, logical grouping 1102 can include an electrical component for accessing a frequency domain binary pseudo-noise (PN) sequence aᵢ, i=0, 1, . . . , m−1 comprising a binary maximum length shift register sequence (m-sequence) whose members are mapped to ±1 from {0, 1} 1106. Further, logical grouping 1102 can include an electrical component for generating a family of total number k of time domain sequence spectrum by cyclically shifting the frequency domain binary PN sequence within the plurality m of frequency domain available consecutive tones 1108. In addition, logical grouping 1102 can include an electrical component for demodulating a series p=1, 2, . . . , k of sequence spectrum of the received data packet communication sequence using the family of time domain PN sequences, wherein the tones of the received data packet communication signal are modulated by a modulation code a_{mod(i+Δ(p-1),m)} 1110. Additionally, system 1100 can include a memory 1112 that retains instructions for executing functions associated with electrical components 1104, 1106, 1108 and 1110. While shown as being external to memory 1112, it is to be understood that one or more of electrical components 1104, 1106, 1108, and 1110 can exist within memory 1112. The frequency step Δ is selected to avoid frequency acquisition ambiguity. The family of frequency domain PN sequences provides a low time domain peak-to-average (PAR) ratio, each PN sequence provides perfect autocorrelation thus zero out-of-phase correlation, any pair of PN sequences has substantially perfect cross-correlation; and sequence correlation in frequency domain achieved with addition-only or addition and subtraction-only operations.

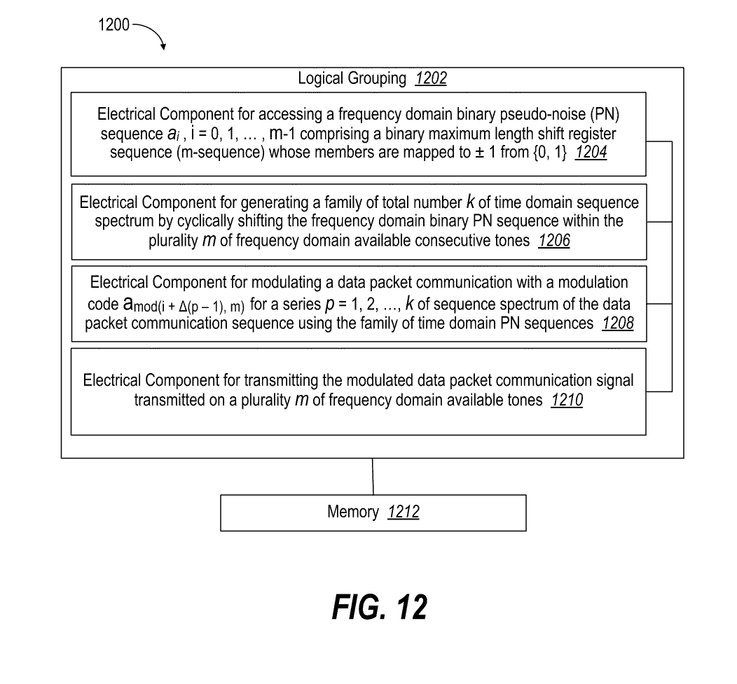

In FIG. 12, a system 1200 is depicted for transmitting wireless communication using a family of time domain pseudo-noise (PN) sequences based upon a frequency domain base PN sequence. For example, system 1200 can reside at least partially within a network entity such as base node. It is to be appreciated that system 1200 is represented as including functional blocks, which can be functional blocks that represent functions implemented by a processor, software, or combination thereof (e.g., firmware). System 1200 includes a logical grouping 1202 of electrical components that can act in conjunction. For instance, logical grouping 1202 can include an electrical component for accessing a frequency domain binary pseudo-noise (PN) sequence aᵢ, i=0, 1, . . . , m−1 comprising a binary maximum length shift register sequence (m-sequence) whose members are mapped to ±1 from {0, 1} 1204. Moreover, logical grouping 1202 can include an electrical component for generating a family of total number k of time domain sequence spectrum by cyclically shifting the frequency domain binary PN sequence within the plurality m of frequency domain available consecutive tones 1206. Further, logical grouping 1202 can include an electrical component for modulating a data packet communication with a modulation code a_{mod(i+Δ(p-1),m)} for a series p=1, 2, . . . , k of sequence spectrum of the data packet communication sequence using the family of time domain PN sequences 1208. In addition, logical grouping 1202 can include an electrical component for transmitting the modulated data packet communication signal transmitted on a plurality m of frequency domain available tones 1210. Additionally, system 1200 can include a memory 1212 that retains instructions for executing functions associated with electrical components 1204, 1206, 1208 and 1210. While shown as being external to memory 1212, it is to be understood that one or more of electrical components 1204, 1206, 1208, and 1210 can exist within memory 1212. The frequency step Δ is selected to avoid frequency acquisition ambiguity. The family of frequency domain PN sequences provides low time domain peak-to-average (PAR) ratio, each PN sequence provides perfect autocorrelation thus zero out-of-phase correlation, any pair of PN sequences has substantially perfect cross-correlation; and sequence correlation in frequency domain achieved with addition-only or addition and subtraction-only operations.

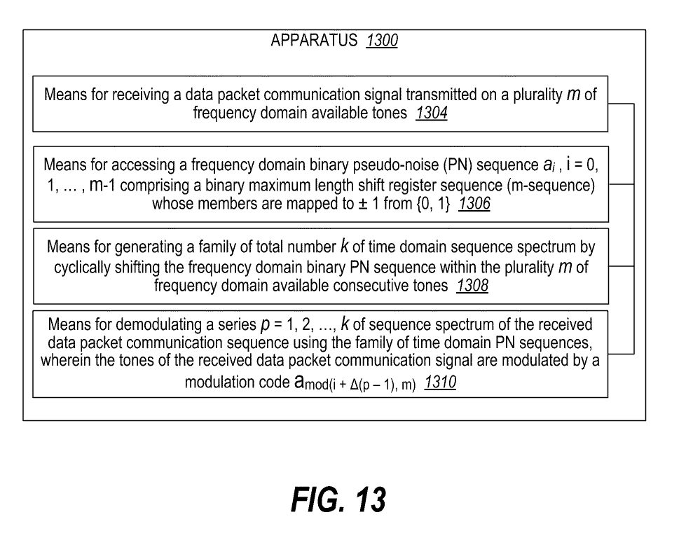

In FIG. 13, an apparatus 1300 is depicted for receiving wireless communication using a family of time domain pseudo-noise (PN) sequences based upon a frequency domain base PN sequence. For example, apparatus 1300 can reside at least partially within user equipment (UE). For instance, apparatus 1300 can includes means for receiving a data packet communication signal transmitted on a plurality m of frequency domain available tones 1304. Moreover, apparatus 1300 can includes means for accessing a frequency domain binary pseudo-noise (PN) sequence aᵢ, i=0, 1, . . . , m−1 comprising a binary maximum length shift register sequence (m-sequence) whose members are mapped to ±1 from {0, 1} 1306. Further, apparatus 1300 can includes means for generating a family of total number k of time domain sequence spectrum by cyclically shifting the frequency domain binary PN sequence within the plurality m of frequency domain available consecutive tones 1308. In addition, apparatus 1300 can includes means for demodulating a series p=1, 2, . . . , k of sequence spectrum of the received data packet communication sequence using the family of time domain PN sequences, wherein the tones of the received data packet communication signal are modulated by a modulation code a_{mod(i+Δ(p-1),m)} 1310. The frequency step Δ is selected to avoid frequency acquisition ambiguity. The family of frequency domain PN sequences provides a low time domain peak-to-average (PAR) ratio, each PN sequence provides perfect autocorrelation thus zero out-of-phase correlation, any pair of PN sequences has substantially perfect cross-correlation; and sequence correlation in frequency domain achieved with addition-only or addition and subtraction-only operations.

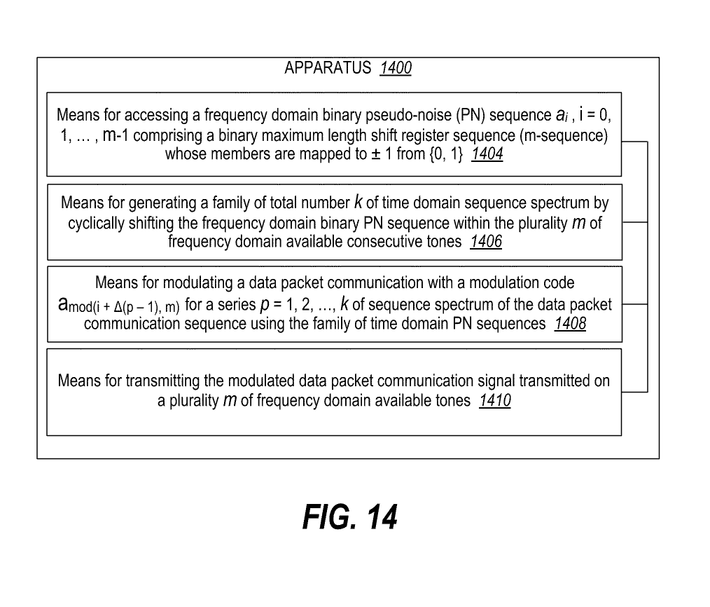

In FIG. 14, an apparatus 1400 is depicted for transmitting wireless communication using a family of time domain pseudo-noise (PN) sequences based upon a frequency domain base PN sequence. For example, apparatus 1400 can reside at least partially within a network entity such as base node. For instance, apparatus 1400 can include means for accessing a frequency domain binary pseudo-noise (PN) sequence aᵢ, i=0, 1, . . . , m−1 comprising a binary maximum length shift register sequence (m-sequence) whose members are mapped to ±1 from {0, 1} 1404. Moreover, apparatus 1400 can include means for generating a family of total number k of time domain sequence spectrum by cyclically shifting the frequency domain binary PN sequence within the plurality m of frequency domain available consecutive tones 1406. Further, apparatus 1400 can include means for modulating a data packet communication with a modulation code a_{mod(i+Δ(p-1),m)} for a series p=1, 2, . . . , k of sequence spectrum of the data packet communication sequence using the family of time domain PN sequences 1408. In addition, apparatus 1400 can include means for transmitting the modulated data packet communication signal transmitted on a plurality m of frequency domain available tones 1410. The frequency step Δ is selected to avoid frequency acquisition ambiguity. The family of frequency domain PN sequences provides low time domain peak-to-average (PAR) ratio, each PN sequence provides perfect autocorrelation thus zero out-of-phase correlation, any pair of PN sequences has substantially perfect cross-correlation; and sequence correlation in frequency domain achieved with addition-only or addition and subtraction-only operations.

What has been described above includes examples of one or more embodiments. It is, of course, not possible to describe every conceivable combination of components or methodologies for the purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method for receiving wireless communication using a family of time domain pseudo-noise (PN) sequences based upon a frequency domain base PN sequence, comprising:
employing a processor executing computer executable instructions stored on a computer readable storage medium to implement the following acts:
receiving a data packet communication signal transmitted on a plurality m of frequency domain available tones;
accessing a frequency domain binary pseudo-noise (PN) sequence aᵢ, i=0, 1, . . . , m−1 comprising a binary maximum length shift register sequence (m-sequence) whose members are mapped to ±1 from {0, 1};
generating a family of total number k of time domain sequence spectrum by cyclically shifting the frequency domain binary PN sequence within the plurality m of frequency domain available consecutive tones; and
demodulating a series p=1, 2, . . . , k of sequence spectrum of the received data packet communication sequence using the family of time domain PN sequences
wherein the family of frequency domain PN sequences provides low time domain peak-to-average (PAR) ratio, each PN sequence provides perfect autocorrelation thus zero out-of-phase correlation, any pair of PN sequences has substantially perfect cross-correlation; and sequence correlation in frequency domain achieved with addition-only or addition and subtraction-only operations.

2. The method of claim 1, further comprising performing cell acquisition using frequency domain PN sequence signals.

3. The method of claim 1, further comprising performing cell identification using frequency domain PN sequence signals.

4. The method of claim 1, further comprising performing frequency acquisition using frequency domain PN sequence signals.

5. The method of claim 1, further comprising performing time acquisition using frequency domain PN sequence signals.

6. The method of claim 1, further comprising demodulating received control information modulated onto frequency domain PN sequence as a spreading sequence.

7. The method of claim 1, further comprising demodulating received data code modulated onto frequency domain PN sequence as a spreading sequence.

8. The method of claim 1, further comprising demodulating received control information that was code multiplexed with frequency domain PN sequences.

9. The method of claim 1, further comprising demodulating received data code that was code multiplexed with frequency domain PN sequences.

10. The method of claim 1, wherein the tones of the received data packet communication signal are modulated by a modulation code a_{mod(i+Δ(p-1),m)}.

11. The method of claim 10, wherein frequency step Δ is selected to avoid frequency acquisition ambiguity,

12. A computer program product for receiving wireless communication using a family of time domain pseudo-noise (PN) sequences based upon a frequency domain base PN sequence, comprising:
at least one computer readable storage medium storing computer executable instructions that when executed by at least one processor implement components comprising:
a set of codes for causing a computer to receive a data packet communication signal transmitted on a plurality m of frequency domain available tones;
a set of codes for causing the computer to access a frequency domain binary pseudo-noise (PN) sequence aᵢ, i=0, 1, . . . , m−1 comprising a binary maximum length shift register sequence (m-sequence) whose members are mapped to ±1 from {0, 1};
a set of codes for causing the computer to generate a family of total number k of time domain sequence spectrum by cyclically shifting the frequency domain binary PN sequence within the plurality m of frequency domain available consecutive tones; and
a set of codes for causing the computer to demodulate a series p=1, 2, . . . , k of sequence spectrum of the received data packet communication sequence using the family of time domain PN sequences,
wherein the family of frequency domain PN sequences provides low time domain peak-to-average (PAR) ratio, each PN sequence provides perfect autocorrelation thus zero out-of-phase correlation, any pair of PN sequences has substantially perfect cross-correlation; and sequence correlation in frequency domain achieved with addition-only or addition and subtraction-only operations.

13. An apparatus for receiving wireless communication using a family of time domain pseudo-noise (PN) sequences based upon a frequency domain base PN sequence, comprising:
at least one processor;
at least one computer readable storage medium storing computer executable instructions that when executed by the at least one processor implement components comprising:
means for receiving a data packet communication signal transmitted on a plurality m of frequency domain available tones;
means for accessing a frequency domain binary pseudo-noise (PN) sequence aᵢ, i=0, 1, . . . , m−1 comprising a binary maximum length shift register sequence (m-sequence) whose members are mapped to ±1 from {0, 1};
means for generating a family of total number k of time domain sequence spectrum by cyclically shifting the frequency domain binary PN sequence within the plurality m of frequency domain available consecutive tones; and
means for demodulating a series p=1, 2, . . . , k of sequence spectrum of the received data packet communication sequence using the family of time domain PN sequences,
wherein the family of frequency domain PN sequences provides low time domain peak-to-average (PAR) ratio, each PN sequence provides perfect autocorrelation thus zero out-of-phase correlation, any pair of PN sequences has substantially perfect cross-correlation; and sequence correlation in frequency domain achieved with addition-only or addition and subtraction-only operations.

14. An apparatus for receiving wireless communication using a family of time domain pseudo-noise (PN) sequences based upon a frequency domain base PN sequence, comprising:
a receiver for receiving a data packet communication signal transmitted on a plurality m of frequency domain available tones;
a computer-readable storage medium for accessing a frequency domain binary pseudo-noise (PN) sequence aᵢ, i=0, 1, . . . , m−1 comprising a binary maximum length shift register sequence (m-sequence) whose members are mapped to ±1 from {0, 1};
a computing platform for generating a family of total number k of time domain sequence spectrum by cyclically shifting the frequency domain binary PN sequence within the plurality m of frequency domain available consecutive tones; and
a demodulator for demodulating a series p=1, 2, . . . , k of sequence spectrum of the received data packet communication sequence using the family of time domain PN sequences,
wherein the family of frequency domain PN sequences provides low time domain peak-to-average (PAR) ratio, each PN sequence provides perfect autocorrelation thus zero out-of-phase correlation, any pair of PN sequences has substantially perfect cross-correlation; and sequence correlation in frequency domain achieved with addition-only or addition and subtraction-only operations.

15. The apparatus of claim 14, wherein the computing platform is further for performing cell acquisition using frequency domain PN sequence signals.

16. The apparatus of claim 14, wherein the computing platform is further for performing cell identification using frequency domain PN sequence signals.

17. The apparatus of claim 14, wherein the computing platform is further for performing frequency acquisition using frequency domain PN sequence signals.

18. The apparatus of claim 14, wherein the computing platform is further for performing time acquisition using frequency domain PN sequence signals.

19. The apparatus of claim 14, wherein the computing platform is further for demodulating received control information modulated onto frequency domain PN sequence as a spreading sequence.

20. The apparatus of claim 14, wherein the computing platform is further for demodulating received data code modulated onto frequency domain PN sequence as a spreading sequence.

21. The apparatus of claim 14, wherein the computing platform is further for demodulating received control information that was code multiplexed with frequency domain PN sequences.

22. The apparatus of claim 14, wherein the computing platform is further for demodulating received data code that was code multiplexed with frequency domain PN sequences.

23. The apparatus of claim 14, wherein the tones of the received data packet communication signal are modulated by a modulation code a_{mod(i+Δ(p-1),m)}.

24. The apparatus of claim 23, wherein frequency step Δ is selected to avoid frequency acquisition ambiguity.

25. A method for transmitting wireless communication using a family of time domain pseudo-noise (PN) sequences based upon a frequency domain base PN sequence, comprising:
employing a processor executing computer executable instructions stored on a computer readable storage medium to implement the following acts:
accessing a frequency domain binary pseudo-noise (PN) sequence aᵢ, i=0, 1, . . . , m−1 comprising a binary maximum length shift register sequence (m-sequence) whose members are mapped to ±1 from {0, 1};
generating a family of total number k of time domain sequence spectrum by cyclically shifting the frequency domain binary PN sequence within the plurality m of frequency domain available consecutive tones; and
modulating a data packet communication using the family of time domain PN sequences; and
transmitting the modulated data packet communication signal transmitted on a plurality m of frequency domain available tones,
wherein the family of frequency domain PN sequences provides low time domain peak-to-average (PAR) ratio, each PN sequence provides perfect autocorrelation thus zero out-of-phase correlation, any pair of PN sequences has substantially perfect cross-correlation; and sequence correlation in frequency domain achieved with addition-only or addition and subtraction-only operations.

26. The method of claim 25, further comprising transmitting the data packet communication for a receiving terminal to perform cell acquisition using frequency domain PN sequence signals.

27. The method of claim 25, further comprising transmitting the data packet communication for a receiving terminal to perform cell identification using frequency domain PN sequence signals.

28. The method of claim 25, further comprising transmitting the data packet communication for a receiving terminal to perform frequency acquisition using frequency domain PN sequence signals.

29. The method of claim 25, further comprising transmitting the data packet communication for a receiving terminal to perform time acquisition using frequency domain PN sequence signals.

30. The method of claim 25, further comprising transmitting the data packet communication comprising control information modulated onto frequency domain PN sequence as a spreading sequence.

31. The method of claim 25, further comprising transmitting the data packet communication comprising data code modulated onto frequency domain PN sequence as a spreading sequence.

32. The method of claim 25, further comprising transmitting the data packet communication comprising control information by code multiplexing with frequency domain PN sequences.

33. The method of claim 25, further comprising transmitting the data packet communication by code multiplexing with frequency domain PN sequences.

34. The method of claim 25, further comprising modulating the data packet communication with a modulation code a_{mod(i+Δ(p-1),m)} for a series p=1, 2, . . . , k of sequence spectrum of the data packet communication sequence using the family of time domain PN sequences.

35. The method of claim 34, further comprising selecting frequency step Δ to avoid frequency acquisition ambiguity.

36. A computer program product for transmitting wireless communication using a family of time domain pseudo-noise (PN) sequences based upon a frequency domain base PN sequence, comprising:
at least one computer readable storage medium storing computer executable instructions that when executed by at least one processor implement components comprising:
a set of codes for causing a computer to access a frequency domain binary pseudo-noise (PN) sequence aᵢ, i=0, 1, . . . , m−1 comprising a binary maximum length shift register sequence (m-sequence) whose members are mapped to ±1 from {0, 1};
a set of codes for causing the computer to generate a family of total number k of time domain sequence spectrum by cyclically shifting the frequency domain binary PN sequence within the plurality m of frequency domain available consecutive tones; and
a set of codes for causing the computer to modulate a data packet communication using the family of time domain PN sequences; and
a set of codes for causing the computer to transmit the modulated data packet communication signal transmitted on a plurality m of frequency domain available tones,
wherein the family of frequency domain PN sequences provides low time domain peak-to-average (PAR) ratio, each PN sequence provides perfect autocorrelation thus zero out-of-phase correlation, any pair of PN sequences has substantially perfect cross-correlation; and sequence correlation in frequency domain achieved with addition-only or addition and subtraction-only operations.

37. An apparatus for transmitting wireless communication using a family of time domain pseudo-noise (PN) sequences based upon a frequency domain base PN sequence, comprising:
at least one processor;
at least one computer readable storage medium storing computer executable instructions that when executed by the at least one processor implement components comprising:
means for accessing a frequency domain binary pseudo-noise (PN) sequence aᵢ, i=0, 1, . . . , m−1 comprising a binary maximum length shift register sequence (m-sequence) whose members are mapped to ±1 from {0, 1};
means for generating a family of total number k of time domain sequence spectrum by cyclically shifting the frequency domain binary PN sequence within the plurality m of frequency domain available consecutive tones; and
means for modulating a data packet communication using the family of time domain PN sequences; and
means for transmitting the modulated data packet communication signal transmitted on a plurality m of frequency domain available tones,
wherein the family of frequency domain PN sequences provides low time domain peak-to-average (PAR) ratio, each PN sequence provides perfect autocorrelation thus zero out-of-phase correlation, any pair of PN sequences has substantially perfect cross-correlation; and sequence correlation in frequency domain achieved with addition-only or addition and subtraction-only operations.

38. An apparatus for transmitting wireless communication using a family of time domain pseudo-noise (PN) sequences based upon a frequency domain base PN sequence, comprising:
a computer-readable storage medium for accessing a frequency domain binary pseudo-noise (PN) sequence aᵢ, i=0, 1, . . . , m−1 comprising a binary maximum length shift register sequence (m-sequence) whose members are mapped to ±1 from {0, 1};
a computing platform for generating a family of total number k of time domain sequence spectrum by cyclically shifting the frequency domain binary PN sequence within the plurality m of frequency domain available consecutive tones; and
a modulator for modulating a data packet communication using the family of time domain PN sequences; and
a transmitter for transmitting the modulated data packet communication signal transmitted on a plurality m of frequency domain available tones,
wherein the family of frequency domain PN sequences provides low time domain peak-to-average (PAR) ratio, each PN sequence provides perfect autocorrelation thus zero out-of-phase correlation, any pair of PN sequences has substantially perfect cross-correlation; and sequence correlation in frequency domain achieved with addition-only or addition and subtraction-only operations.

39. The apparatus of claim 38, wherein the computing platform is further for transmitting the data packet communication for a receiving terminal to perform cell acquisition using frequency domain PN sequence signals.

40. The apparatus of claim 38, wherein the computing platform is further for transmitting the data packet communication for a receiving terminal to perform cell identification using frequency domain PN sequence signals.

41. The apparatus of claim 38, wherein the computing platform is further for transmitting the data packet communication for a receiving terminal to perform frequency acquisition using frequency domain PN sequence signals.

42. The apparatus of claim 38, wherein the computing platform is further for transmitting the data packet communication for a receiving terminal to perform time acquisition using frequency domain PN sequence signals.

43. The apparatus of claim 38, wherein the computing platform is further for transmitting the data packet communication comprising control information by modulating onto frequency domain PN sequence as a spreading sequence.

44. The apparatus of claim 38, wherein the computing platform is further for transmitting the data packet communication comprising data code by modulating onto frequency domain PN sequence as a spreading sequence.

45. The apparatus of claim 38, wherein the computing platform is further for transmitting the data packet communication comprising control information by code multiplexing using frequency domain PN sequence signals.

46. The apparatus of claim 38, wherein the computing platform is further for transmitting the data packet communication comprising data code by code multiplexing using frequency domain PN sequence signals.

47. The apparatus of claim 38, wherein the modulator is further for modulating the data packet communication with a modulation code a_{mod(i+Δ(p-1),m)} for a series p=1, 2, . . . , k of sequence spectrum of the data packet communication sequence using the family of time domain PN sequences.

48. The apparatus of claim 47, wherein the modulator is further for selecting frequency step Δ to avoid frequency acquisition ambiguity.
